(19) United States
(12) Patent Application Publication
(10) Pub. No.: US 2026/0022134 A1
(43) Pub. Date: Jan. 22, 2026

(54) N-HETEROCYCLE-CONTAINING BORIC ACID COMPOUND AND PREPARATION METHOD AND APPLICATION THEREOF

(71) Applicant: Hangzhou City University, Hangzhou (CN)

(72) Inventors: Linghui ZENG, Hangzhou (CN); Chong ZHANG, Hangzhou (CN); Zhidi LI, Hangzhou (CN); Jiaan SHAO, Hangzhou (CN); Tingting ZHAO, Hangzhou (CN)

(73) Assignee: Hangzhou City University, Hangzhou (CN)

(21) Appl. No.: 18/996,005

(22) PCT Filed: Feb. 17, 2023
(86) PCT No.: PCT/CN2023/076921

§ 371 Date: Jan. 17, 2025

(30) Foreign Application Priority Data
Oct. 28, 2022 (CN) 202211337963.1

(51) Int. Cl. C07F 5/02

(52) U.S. Cl. CPC C07F 5/02

(57) ABSTRACT

An N-heterocycle-containing boric acid compound and a preparation method and application thereof are provided. The preparation method adopts 3-bromo-1-p-tosyl-1H-pyrrolo[2, 3-b]pyrimidine as a raw material to generate (3-((5-chloro-4-(1H-pyrrolo[2,3-b]pyridin-3-yl)pyrimidin-2-yl)amino)phenyl)boric acid by three steps of reaction. The (3-((5-chloro-4 (1H-pyrrolo[2,3-b]pyridin-3-yl)pyrimidin-2-yl)amino)phenyl)boric acid has good inhibition effect on the proliferation activity of brain glioma, which is proven by cell experiments.

### CROSS REFERENCE TO THE RELATED APPLICATIONS

This application is the national phase entry of International Application No. PCT/CN2023/076921, filed on Feb. 17, 2023, which is based upon and claims priority to Chinese Patent Application No. 202211337963.1, filed on Oct. 28, 2022, the entire contents of which are incorporated herein by reference.

### TECHNICAL FIELD

The present disclosure relates to the field of organic synthesis and pharmaceutical chemistry and in particular to an N-heterocycle-containing boric acid compound and a preparation method and application thereof.

### BACKGROUND

Brain glioma is the most common malignant tumor in central nervous system, about accounting for 80% of malignant brain tumors, with its yearly incidence rate of adults ranging between 2.2 to 3.7/100 thousand persons. The brain glioma has the characteristics of high recurrence rate, high mortality rate and bad prognosis, and the patients have a one-year survival rate of 35.7% and a five-year survival rate of <5%. Due to its invasive growth, frequent occurrence in important function areas and deep parts of brain and insufficient researches on its pathogenesis, there is still a shortage of a corresponding effective drug for treatment of brain glioma. Therefore, its treatment method has been a hot topic in the research of neural science field.

At present, in the clinical treatment of the brain glioma, the following standard treatment method is mostly adopted: under the condition of protecting brain functions, the tumors are resected as possible with postoperative concurrent chemoradiotherapy performed. However, the patients with grade-II to III brain glioma mostly suffer recurrence in a couple of years following the treatment. The patients with grade-IV brain glioma usually suffer recurrence in one year following the treatment. The median survival time of the patients is only 12 months and the five-year survival rate is only at 10%.

Therefore, it is urgent to develop a drug for treating brain glioma to satisfy the clinical requirements.

### SUMMARY

In view the above, an example of the present disclosure provides an N-heterocycle-containing boric acid compound and a preparation method and application thereof.

According to an example of the present disclosure, there is provided an N-heterocycle-containing boric acid compound, with its structural formula as shown in formula (1):

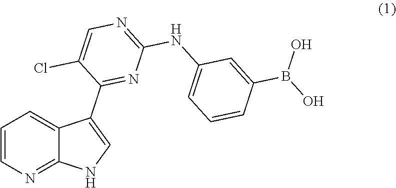 [SMILES: OB(O)c1cccc(Nc2ncc(Cl)c(-c3c[nH]c4ncccc34)n2)c1]

The name of the chemical formula of the compound is (3-((5-chloro-4-(1H-pyrrolo[2,3-b]pyridin-3-yl)pyrimidin-2-yl)amino)phenyl)boric acid.

The preparation method of the above N-heterocycle-containing boric acid compound can be carried out in the following synthesis route:

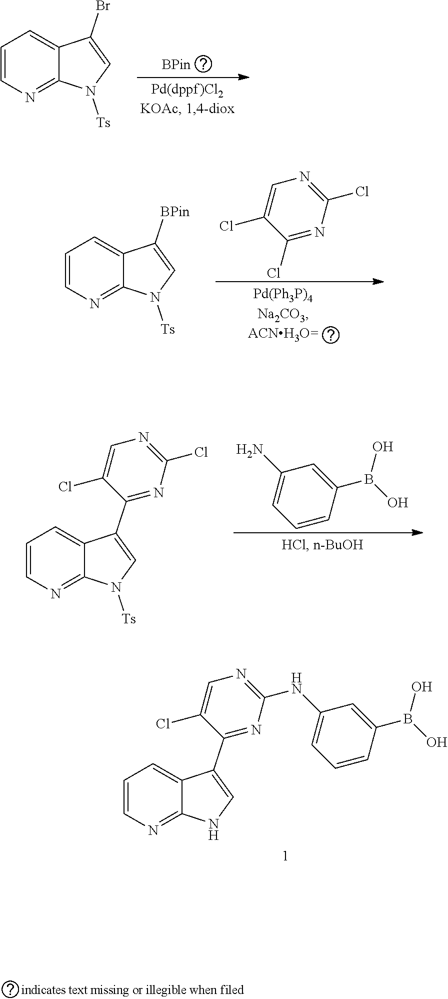

The preparation method of the above (3-((5-chloro-4-(1H-pyrrolo[2,3-b]pyridin-3-yl)pyrimidin-2-yl)amino)phenyl)boric acid includes the following steps:
(1) 3-bromo-1-p-tosyl-1H-pyrrolo[2,3-b]pyrimidine and bis(pinacolato)diboron generate 3-(4,4,5,5-tetramethyl-1,3,2-dioxaborolan-2-yl)-1-tos-1H-pyrrolo[2,3-b]pyridine under the catalysis of [1,1′-bis(diphenylphosphino)ferrocene]dichloropalladium;
(2) 3-(4,4,5,5-tetramethyl-1,3,2-dioxaborolan-2-yl)-1-tos-1H-pyrrolo[2,3-b]pyridine and 2,4,5-trichloropyrimidine generate 3-(2,5-dichloropyrimidin-4-yl)-1-p-tolyl-1H-pyrrolo[2,3-b]pyridine under the catalysis of tetrakis(triphenylphosphin)palladium;
(3) 3-(2,5-dichloropyrimidin-4-yl)-1-p-tolyl-1H-pyrrolo[2,3-b]pyridine and 3-aminophenylboronic acid are refluxed in 5% HCl n-butyl alcohol solution to obtain the target compound (3-((5-chloro-4-(1H-pyrrolo[2,3-b]pyridin-3-yl)pyrimidin-2-yl)amino)phenyl)boric acid.

The preparation method of the above N-heterocycle-containing boric acid compound can include the following steps:
(1) 3-bromo-1-p-tosyl-1H-pyrrolo[2,3-b]pyrimidine, bis(pinacolato)diboron and potassium acetate are dissolved in ethylene glycol dimethyl ether and added with [1,1′-bis(diphenylphosphino)ferrocene]dichloropalladium under the protection of nitrogen, and displaced with nitrogen several times for reaction at the temperature of 90° C.; and after complete reaction, the reaction liquid is cooled and filtered and the filtrate is spin-dried and directly subjected to silica gel mixing and run through column to obtain 3-(4,4,5,5-tetramethyl-1,3,2-dioxaborolan-2-yl)-1-tos-1H-pyrrolo[2,3-b]pyridine;
(2) 3-(4,4,5,5-tetramethyl-1,3,2-dioxaborolan-2-yl)-1-tos-1H-pyrrolo[2,3-b]pyridine, 2,4,5-trichloropyrimidine and sodium carbonate are dissolved in acetonitrile solution, and added with tetrakis(triphenylphosphin)palladium under the protection of nitrogen, and then displaced with nitrogen several times for reaction at the temperature of 85° C.; after complete reaction, the reaction liquid is cooled and filtered, and the filter cake is washed with water and vacuum-dried to obtain 3-(2,5-dichloropyrimidin-4-yl)-1-p-tolyl-1H-pyrrolo[2,3-b]pyridine;
(3) 3-(2,5-dichloropyrimidin-4-yl)-1-p-tolyl-1H-pyrrolo[2,3-b]pyridine and 3-aminophenylboronic acid are dissolved in n-butyl alcohol, and added dropwise with concentrated hydrochloric acid, and subjected to reflux reaction; after the solvent is evaporation-dried, the system is directly subjected to silica gel mixing and run through column to obtain (3-((5-chloro-4-(1H-pyrrolo[2,3-b]pyridin-3-yl)pyrimidin-2-yl)amino)phenyl)boric acid.

There is also provided an application of the above N-heterocycle-containing boric acid compound in the preparation of the drug for treating brain glioma. Through cell experiments, the present disclosure proves that the compound has good inhibition effect on the proliferation activity of brain glioma.

### BRIEF DESCRIPTION OF THE DRAWINGS

The drawings herein incorporated into the specification and constituting a part of the specification illustrate the examples consistent with the present disclosure and interpret the principle of the present disclosure together with the specification.

FIG. 1 is nuclear magnetic hydrogen spectra illustrating (3-((5-chloro-4-(1H-pyrrolo[2,3-b]pyridin-3-yl)pyrimidin-2-yl)amino)phenyl)boric acid according to an example of the present disclosure.

FIG. 2 is a result diagram illustrating proliferation effect of (3-((5-chloro-4-(1H-pyrrolo[2,3-b]pyridin-3-yl)pyrimidin-2-yl)amino)phenyl)boric acid for action of 24, 48 and 72h in the glioma cells according to an example of the present disclosure, where S3 is (3-((5-chloro-4-(1H-pyrrolo[2,3-b]pyridin-3-yl)pyrimidin-2-yl)amino)phenyl)boric acid.

FIG. 3 is a result diagram illustrating colony formation ability effect of (3-((5-chloro-4-(1H-pyrrolo[2,3-b]pyridin-3-yl)pyrimidin-2-yl)amino)phenyl)boric acid in glioma cells according to an example of the present disclosure, where S3 is (3-((5-chloro-4-(1H-pyrrolo[2,3-b]pyridin-3-yl)pyrimidin-2-yl)amino)phenyl)boric acid.

FIG. 4 is a result diagram illustrating cell cycle arrest of (3-((5-chloro-4-(1H-pyrrolo[2,3-b]pyridin-3-yl)pyrimidin-2-yl)amino)phenyl)boric acid for action of 24 h in glioma cells U251 according to an example of the present disclosure, where S3 is (3-((5-chloro-4-(1H-pyrrolo[2,3-b]pyridin-3-yl)pyrimidin-2-yl)amino)phenyl)boric acid.

FIG. 5 is a result diagram illustrating cell cycle arrest of (3-((5-chloro-4-(1H-pyrrolo[2,3-b]pyridin-3-yl)pyrimidin-2-yl)amino)phenyl)boric acid for action of 24 h in glioma cells U87 according to an example of the present disclosure, where S3 is (3-((5-chloro-4-(1H-pyrrolo[2,3-b]pyridin-3-yl)pyrimidin-2-yl)amino)phenyl)boric acid.

FIG. 6 is a result diagram illustrating protein change related to proliferation-related signal pathway in the Western blot-detected cells after action of 48 h of (3-((5-chloro-4-(1H-pyrrolo[2,3-b]pyridin-3-yl)pyrimidin-2-yl)amino)phenyl)boric acid in glioma cells U251 and U87 according to an example of the present disclosure, where S3 is (3-((5-chloro-4-(1H-pyrrolo[2,3-b]pyridin-3-yl)pyrimidin-2-yl)amino)phenyl)boric acid.

FIG. 7 is a result diagram illustrating protein change related to cell cycle in the Western blot-detected cells after action of 48 h of (3-((5-chloro-4-(1H-pyrrolo[2,3-b]pyridin-3-yl)pyrimidin-2-yl)amino)phenyl)boric acid in glioma cells U251 according to an example of the present disclosure, where S3 is (3-((5-chloro-4-(1H-pyrrolo[2,3-b]pyridin-3-yl)pyrimidin-2-yl)amino)phenyl)boric acid.

FIG. 8 is a result diagram illustrating effect of (3-((5-chloro-4-(1H-pyrrolo[2,3-b]pyridin-3-yl)pyrimidin-2-yl)amino)phenyl)boric acid on the cell migration ability of the glioma cells U251 and A172 after action of 24 h according to an example of the present disclosure, where S3 is (3-((5-chloro-4-(1H-pyrrolo[2,3-b]pyridin-3-yl)pyrimidin-2-yl)amino)phenyl)boric acid.

### DETAILED DESCRIPTION OF THE EMBODIMENTS

The present disclosure will be further described in combination with drawings and specific examples.

### Example 1

Preparation of

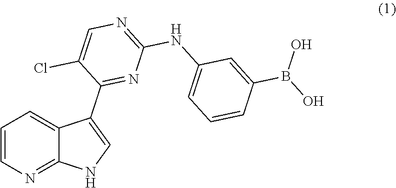 [SMILES: OB(O)c1cccc(Nc2ncc(Cl)c(-c3c[nH]c4ncccc34)n2)c1]

### (1) Preparation of 3-(4,4,5,5-tetramethyl-1,3,2-dioxaborolan-2-yl)-1-tos-1H-pyrrolo[2,3-b]pyridine

3-bromo-1-p-tosyl-1H-pyrrolo[23-b]pyrimidine (21.2 g, 60.5 mmol), bis(pinacolato)diboron (22.40 g, 88. 1 mmol) and potassium acetate (17.9 g, 183 mmol) were dissolved in a IL three-necked bottle holding ethylene glycol dimethyl ether (500 mL), added with [1,1′-bis(diphenylphosphino)ferrocene]dichloropalladium (2.68 g, 3.67 mmol) under the protection of nitrogen, and then displaced with nitrogen three times for reaction of 4 hours at the temperature of 90° C.; and after complete reaction, the reaction liquid was cooled and filtered and the filtrate was spin-dried and directly subjected to silica gel mixing and run through column (ethyl acetate: petroleum ether=0 to 5%) to obtain 3-(4,4,5,5-tetramethyl-1,3,2-dioxaborolan-2-yl)-1-tos-1H-pyrrolo[2,3-b]pyridine, with the yield of 82%.

### (2) Preparation of 3-(2,5-dichloropyrimidin-4-yl)-1-p-tolyl-1H-pyrrolo[2,3-b]pyridine

3-(4,4,5,5-tetramethyl-1,3,2-dioxaborolan-2-yl)-1-tos-1H-pyrrolo[2,3-b]pyridine (5.00 g, 12.5 mmol), 2,4,5-trichloropyrimidine (2.27 g, 12.5 mmol) and sodium carbonate (1.98 g, 18.7 mmol) were dissolved in 100 mL single-mouth bottle holding acetonitrile and water with a ratio of 4:1 (50 mL), added with tetrakis(triphenylphosphin)palladium (1.44 g, 1.25 mmol) under the protection of nitrogen, and then displaced with nitrogen three times for reaction at the temperature of 85° C.; after complete reaction, the reaction liquid was cooled and filtered, and the filter cake was washed with water (40 mL×3) and vacuum-dried to obtain 3-(2,5-dichloropyrimidin-4-yl)-1-p-tolyl-1H-pyrrolo[2,3-b]pyridine, with the yield of 71%.

### (3) Preparation of (3-((5-chloro-4-(1H-pyrrolo[2,3-b]pyridin-3-yl)pyrimidin-2-yl)amino)phenyl)boric acid

3-(2,5-dichloropyrimidin-4-yl)-1-p-tolyl-1H-pyrrolo[2,3-b]pyridine (418 mg, 1 mmol) and 3-aminophenylboronic acid were dissolved in n-butyl alcohol (100 mL), and added with five drops of concentrated hydrochloric acid, and subjected to reflux reaction for 6 hours; after the solvent was evaporation-dried, the system was directly subjected to silica gel mixing and run through column to (3-((5-chloro-4-(1H-pyrrolo[2,3-b]pyridin-3-yl)pyrimidin-2-yl)amino)phenyl)boric acid, with the yield of 67%, and its structural formula as shown below:

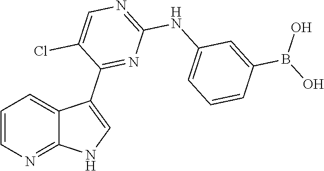 [SMILES: OB(O)c1cccc(Nc2ncc(Cl)c(-c3c[nH]c4ncccc34)n2)c1]

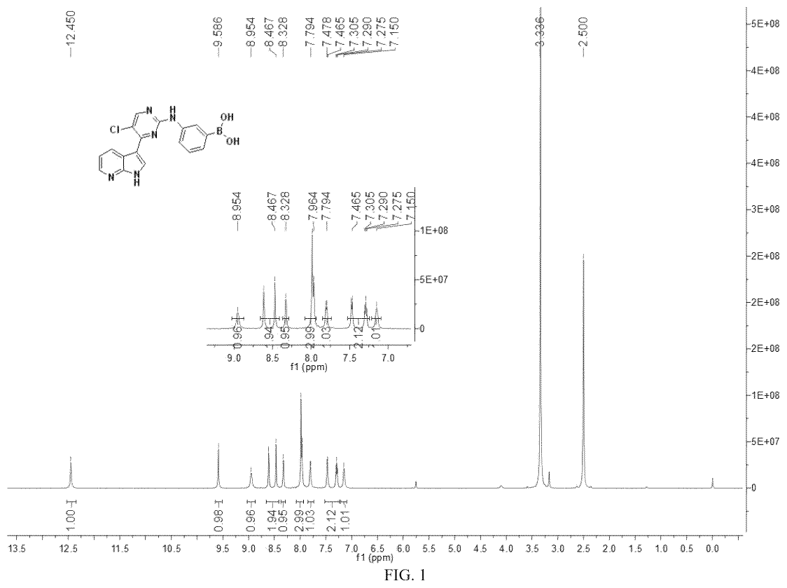

Melting point: 188-190° C. 1H NMR (500 MHz, DMSO) δ 12.45 (s, 1H), 9.59 (S, 1H), 8.95 (s, 1H), 8.61 (s, 1H), 8.47 (s,1H), 8.33 (s, 1H), 7.97 (d, J=10.6 Hz, 3H), 7.80 (d, J=7.0 Hz, 1H), 7.47 (d. J=6.8 Hz, 1H), 7.29 (t. J=7.4 Hz, 1H), 7.15 (s, 1H). HRMS(ESI): m/z calcd for C17H14BClN5O2+:366.0924, found: 366.0925. FIG. 1 is nuclear magnetic hydrogen spectra illustrating (3-((5-chloro-4-(1H-pyrrolo[2,3-b]pyridin-3-yl)pyrimidin-2-yl)amino)phenyl)boric acid according to an example of the present disclosure.

### Example 2 (Activity Evaluation) Application of (3-((5-chloro-4-(1H-pyrrolo[2,3-b]pyridin-3-yl)pyrimidin-2-yl)amino)phenyl)boric Acid in Resisting Glioblastoma

Effect of (3-((5-chloro-4-(1H-pyrrolo[2,3-b]pyridin-3-yl)pyrimidin-2-yl)amino)phenyl)boric acid in proliferation and transfer of glioblastoma

### 1. Experimental Method

### (1) SRB (Sulforhodamine B) Colorimetric Analysis

After passage to the logarithmic phase, the cells were dissociated by 0.25 trypsin-EDTA and blown into single cells, and with a final cell concentration adjusted to 2000 to 2000 pcs/well, inoculated into a 96-well plate with each well 100 μl (edge wells were filled with sterile PBS), 5% CO₂, and 37° C. incubation. After 24 h (until a single layer of cells were spread to 30% to 50% of the well bottom), a cell culture solution containing drugs of corresponding concentrations was added and incubated for 24, 48 and 72 h in a 5% CO₂, 37° C. incubator. Each drug concentration was provided with three parallel wells. The cells were medicate-cultured for 24, 48 and 72 h and then fixed by trichloroacetic acid (TCA). Each well of the cells was fixed by a pre-cooled 15% TCA liquid 100 μl, and then the 96-well plate was moved to 4° C. and stood for 4 h. The fixing liquid was discarded and the 96 wells were washed five times with sterile triple-distilled water and spin-dried and air-dried in 37° C. drying oven. Each well was added with 100 μl 0.4% SRB solution, and kept free from light and stood for 30 min at room temperature. The SRB not combined with proteins was cleaned with 1% glacial acetic acid and air-dried in 37° C. drying oven. The combined SRB was dissolved by 100 μl 10 mM non-buffer Tris alkaline solution (pH 10.5), and oscillated and mixed uniformly and then measured for the OD value on an enzyme-linked immuno detector. By blank control zero setting, the OD value of each well was measured at the position of a wavelength of 570 nm. The obtained growth inhibition rate of the tumor cells was defined as an in vitro inhibition rate of the drug on the tumor cells. The inhibition rate is equal to the OD value of administration group/the OD value of control group×100%.

### (2) Cell Colony-Formation Assay

The cells of the logarithmic phase were taken and dissociated by 0.25% trypsin-EDTA and blown into single cells, and inoculated into the 6-well plate with a density of 2000 to 3000 pcs/well, and gently shaken to disperse the cells uniformly and then placed into 5% CO₂, 37° C. incubator for incubation. After 24 h, the original culture medium was discarded and a fresh cell culture medium containing drugs of corresponding concentrations was then added, and the cells then were incubated in the incubator for about 14 days. During this period, the fresh culture medium containing the drugs of corresponding concentrations was replaced every two or three days. Frequent observation should be made to ensure that when a macroscopic colony appears in the culture plate, the culture was ended. The supernatant was discarded and cleaning was performed carefully twice with PBS. 700 μl 1% crystal violet methanol solution was added for fixation and staining of 30 min, and then the staining solution was washed off slowly with flowing water and then air-drying was carried out. The culture plate was placed on the white light screen and photographed for counting. Finally, the number of the formed colonies was calculated.

### (3) Flow Cytometry

The cells of the logarithmic phase were taken and dissociated by 0.25% trypsin-EDTA and blown into single cells, and inoculated into the 6-well plate with a density of 2000 to 3000 pcs/well, and gently shaken to disperse the cells uniformly and then placed into 5% CO₂, 37° C. incubator for incubation. After 24 h, the original culture medium was discarded and a fresh cell culture medium containing drugs of corresponding concentrations was then added; after the cells were incubated for 24 h, the cells were dissociated by 0.25% trypsin-EDTA and cleaned twice with 1 mL of precooled PBS and then re-suspended with 250 μl PBS and slowly added dropwise into 750 μl of precooled 75% ethyl alcohol, and then fixed at the temperature of −20° C. overnight. Next day, the fixed cells were centrifuged for 5 min at the rotation speed of 1000 rpm, the supernatant was discarded and the cells were then cleaned twice with 1 mL PBS and re-suspended with 1 mL PBS. Propidium iodide (PI) with a final concentration of 50 mg/ml was added for staining of 1 h free from light at room temperature, and then filtered by gauze and then transferred to a flow tube and detected and analyzed by a flow cytometer.

### (4) Transwell Assay

The cells of the logarithmic phase were taken and dissociated by 0.25% trypsin-EDTA and blown into single cells. 200 μL of serum-free culture medium containing 5×10⁴ cells was sucked and added into the Transwell upper chamber and 600 μL of culture medium containing 20% FBS was transferred to the Transwell lower chamber and drugs of corresponding concentrations were added to the upper and lower chambers. Culture was performed for 24 h in the cell incubator. In each well of the 24-well plate, 300 μL of 1% crystal violet methanol solution was added. After the culture medium was sucked and discarded, the Transwell chamber was placed into crystal violet and fixed free from light at room temperature and stained for 30 min. The chamber was picked by tweezers into the PBS buffer solution and washed slowly, and the cells and surplus crystal violet in the upper chamber were gently wiped with a cotton swab and then photographed under microscope for counting to calculate the number of the migrating cells of each group.

### (5) Western Blot Assay

### Sample Preparation

1) Loading buffer method

The cell supernatant was discarded and the cells were washed twice with PBS; based on cell confluence, a corresponding amount of Loading buffer was added, and stirred by a pipette tip while fully covered, and then collected to a centrifuge tube and centrifuged and then placed into a high-temperature metal bath of 100° C. for denaturation of 10 min, then cooled on ice and centrifuged and stored at the temperature of −20° C. for later use in the Western blot. The loading volume was adjusted by Western block pre-experiment to ensure the internal control proteins were uniform.
2) BSA quantitative method

The cells treated by the trypsin dissociation and collection assay were centrifuged for 4 min at the rotation speed of 1500 rpm/min. The supernatant was discarded and the cells were re-suspended and washed with the pre-cooled PBS and then transferred to al. 5 mL Eppendorf tube and then centrifuged again and the supernatant was all discarded. Cell lysis was carried out on ice, and based on a precipitation amount, a proper amount of RIPA lysis solution was added and blown uniform by the pipette and then stood on ice. The cells were whirled or dispersed once every other 10 min, and 30 min later, the cells were put into a pre-cooled 4° C. centrifugal machine and centrifuged for 30 min at the rotation speed of 12000 rpm/min. The supernatant was sucked to a new Eppendorf tube to obtain a protein sample solution.

A standard protein BSA was selected for making a standard curve and the BSA was sequentially half-diluted by 10 factors. The protein sample was diluted with deionized water by 10 factors and 5 μL of diluted sample was sucked to a new Eppendorf tube and then 200 μL of BCA reagent was added to each tube (liquid A: liquid B=50:1) and placed in a 37° C. drying oven for incubation of 30 min After completion of the reaction, the liquid was whirled uniformly and 100 μL was sucked to a 96-well plate and measured for the OD value at the position of the wavelength 562 nm. Based on the standard curve, quantification was performed to sub-package the protein sample and then 5×Loading buffer was added for denaturation of 10 min at the temperature of 100° C., and cooled and centrifuged and then stored at the temperature of −20° C. for later use.
3) Gel preparation: based on the size of target protein molecules, a desired gel was prepared and then solidified and then put into deionized water and stored in 4° C. refrigerator for later use.
4) Electrophoresis: before electrophoresis, the protein sample was heated for 3 to 5 min at the temperature of 100° C. and then cooled and centrifuged and then loaded. A protein marker was added before the sample and then equal-volume or equal-quantity loading was performed in a sequence. After completion of loading, constant-voltage electrophoresis was performed with the voltage adjusted to 70V. Electrophoresis was stopped when the sample runs to a position 1 cm from the bottom glass plate, and transfer was performed.
5) Transfer: 1×Transfer buffer 1000 mL containing 10% anhydrous ethanol was prepared, and the anhydrous ethanol activates PVDF membrane for 1 min and then the membrane was put into a Trans Buffer solution. Based on the target protein molecules, gel cutting was performed, and transfer was carried out based on black gel and white membrane. Under the condition of ice water bath, 330 mA constant-current transfer was performed for 70 min.
6) Blocking: after transfer completion, the membrane was put into 5% skimmed mil powder solution and the shaker was blocked for 1 h at room temperature.
7) Primary antibody incubation: a corresponding primary antibody was prepared for incubation of a target strip. The primary antibody was put into a 4° C. refrigerator and incubated by the shaker overnight. The primary antibody was recovered and the membrane was washed three times with 1×T-PBS, each time for 8 min.
8) Secondary antibody incubation: a fluorescent second antibody marked with horseradish peroxidase and corresponding to the primary antibody was added; incubation was performed for 1h by the shaker at room temperature and the secondary antibody was recovered and the membrane was washed three times with 1×T-PBS, with each time for 8 min, for the purpose of subsequent exposure.
9) Exposure: the membrane was picked by tweezers from a side with protein marker and placed with the front side facing up on an exposure instrument. The target area covered by the strip was selected and a program was selected to perform scanning and imaging.

### 2. Experimental Result

(1) (3-((5-chloro-4-(1H-pyrrolo[2,3-b]pyridin-3-yl)pyrimidin-2-yl)amino)phenyl)boric acid inhibits the cell proliferation ability of the glioblastoma in a time and dose-dependent way:

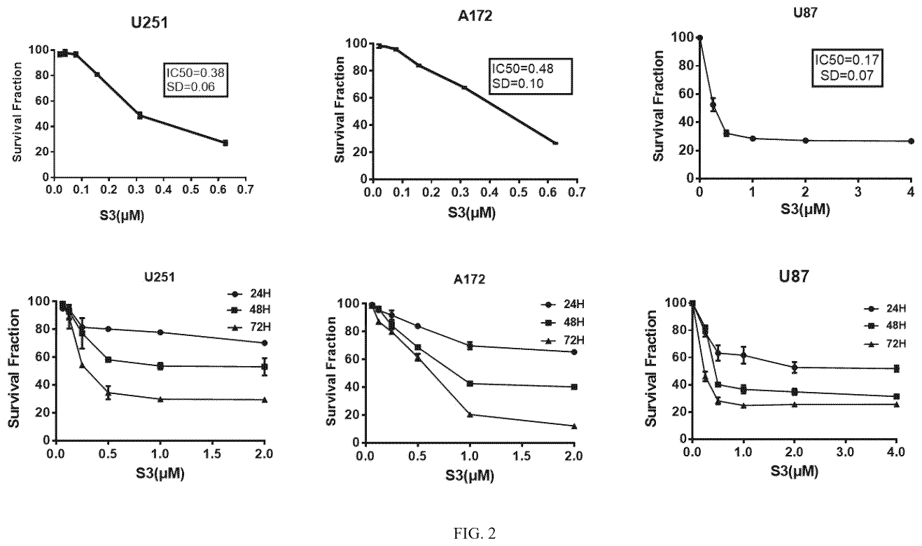

Firstly, we evaluated the growth inhibition effect of (3-((5-chloro-4-(1H-pyrrolo[2,3-b]pyridin-3-yl)pyrimidin-2-yl)amino)phenyl)boric acid on the MG cells U251A172 and U87 of three different glioblastoma cell series. With different concentrations of (3-((5-chloro-4-(1H-pyrrolo[2,3-b]pyridin-3-yl)pyrimidin-2-yl)amino)phenyl)boric acid, the cells U251, A172 and U87 were treated for 24 h, 48 h and 72 h and then based on the SRB detection method, the survival rate of the cells treated by (3-((5-chloro-4-(1H-pyrrolo[2,3-b]pyridin-3-yl)pyrimidin-2-yl)amino)phenyl)boric acid was detected. The result showed that the application of (3-((5-chloro-4-(1H-pyrrolo[2,3-b]pyridin-3-yl)pyrimidin-2-yl)amino)phenyl)boric acid had significant cytotoxic effect on the cells U251, A172 and U87, and the cytotoxic effect had time and dose-dependence. The cytotoxic effect of the U87 was more obvious than those of U251 and A172. The IC50 values of the cells U251, A172 and U87 treated by (3-((5-chloro-4-(1H-pyrrolo[2,3-b]pyridin-3-yl)pyrimidin-2-yl)amino)phenyl)boric acid for 72 h were 0.38 μM, 0.48 μM and 0.17 μM respectively (refer to FIG. 2).
(2) (3-((5-chloro-4-(1H-pyrrolo[2,3-b]pyridin-3-yl)pyrimidin-2-yl)amino)phenyl)boric acid inhibits the cell colony formation ability of the glioblastoma in a dose-dependent way:

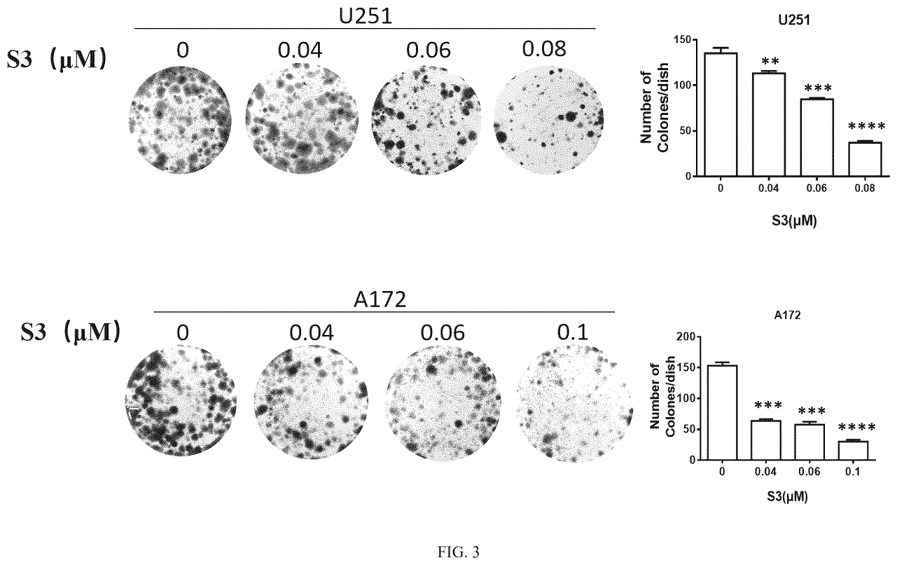

In order to determine the effect of (3-((5-chloro-4-(1H-pyrrolo[2,3-b]pyridin-3-yl)pyrimidin-2-yl)amino)phenyl)boric acid on the cell colony formation ability of the glioblastoma, we treated the cells U251 and A172 with different concentrations of (3-((5-chloro-4-(1H-pyrrolo[2,3-b]pyridin-3-yl)pyrimidin-2-yl)amino)phenyl)boric acid and 14 days later, determined the cell colony formation ability by colony determination. The result showed that the treatment of (3-((5-chloro-4-(1H-pyrrolo[2,3-b]pyridin-3-yl)pyrimidin-2-yl)amino)phenyl)boric acid reduced the number of the cell colonies in a dose-dependent way. The cells A172 had a stronger reaction to the treatment of (3-((5-chloro-4-(1H-pyrrolo[2,3-b]pyridin-3-yl)pyrimidin-2-yl)amino)phenyl)boric acid than the cells U251. The results of cell survival and colony formation assays showed that (3-((5-chloro-4-(1H-pyrrolo[2,3-b]pyridin-3-yl)pyrimidin-2-yl)amino)phenyl)boric acid had resistance to proliferation activity in the GBM cells (refer to FIG. 3).
(3) (3-((5-chloro-4-(1H-pyrrolo[2,3-b]pyridin-3-yl)pyrimidin-2-yl)amino)phenyl)boric acid arrests the G2/M phase of the glioblastoma in a dose-dependent way.

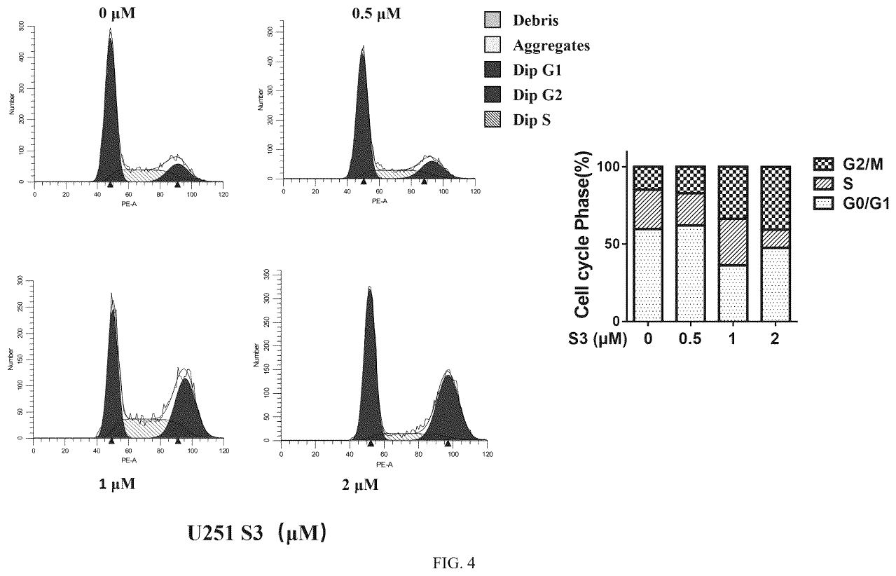

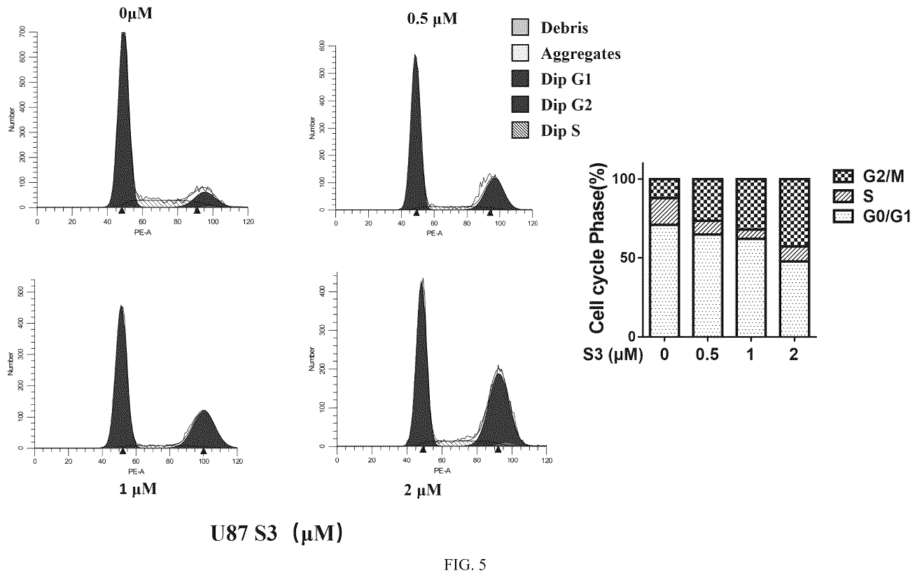

In order to determine the mechanism of the growth inhibition effect of (3-((5-chloro-4-(1H-pyrrolo[2,3-b]pyridin-3-yl)pyrimidin-2-yl)amino)phenyl)boric acid on the cells U251 and U87, after 24 h following the treatment with different concentrations of (3-((5-chloro-4-(1H-pyrrolo[2,3-b]pyridin-3-yl)pyrimidin-2-yl)amino)phenyl)boric acid, the cell cycle was analyzed and evaluated by flow cytometry. The result showed that the G2/M phase of the cells U251 and U87 treated by (3-((5-chloro-4-(1H-pyrrolo[2,3-b]pyridin-3-yl)pyrimidin-2-yl)amino)phenyl)boric acid was slightly increased. After 24 h treatment, the distribution of the G2/M phase of the cells U251 treated by (3-((5-chloro-4-(1H-pyrrolo[2,3-b]pyridin-3-yl)pyrimidin-2-yl)amino)phenyl)boric acid increased from 14.70% to 40.61%, and the distribution of the G2/M phase of the cells U87 treated increased from 11.99% to 42.62% (refer to FIGS. 4 and 5).
(4) (3-((5-chloro-4-(1H-pyrrolo[2,3-b]pyridin-3-yl)pyrimidin-2-yl)amino)phenyl)boric acid lowers the protein expressions of p-STAT3 (Try705), p-AKT (Ser473), p-Erk1/2, c-Myc and Cyclin B1 in a dose-dependent way.

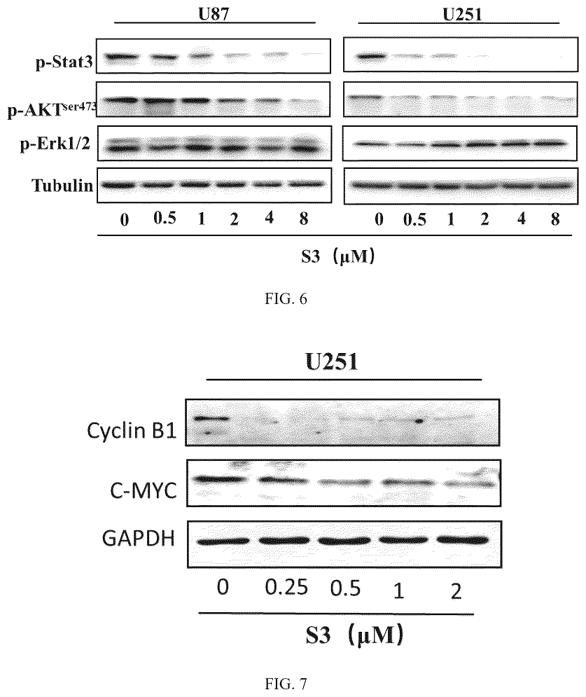

Then, we determined which pathways in the GBM cells treated by (3-((5-chloro-4-(1H-pyrrolo[2,3-b]pyridin-3-yl)pyrimidin-2-yl)amino)phenyl)boric acid were affected. After 24 h following the treatment of (3-((5-chloro-4-(1H-pyrrolo[2,3-b]pyridin-3-yl)pyrimidin-2-yl)amino)phenyl)boric acid on the cells U251 and U87, we used the protein immunoblotting method to detect the change of the cell protein expressions. The results showed that the protein expressions of p-Stat3, p-Akt, c-Myc and Cyclin B1 were decreased whereas the detected p-Erk1/2 protein expressions were increased. The treatment of (3-((5-chloro-4-(1H-pyrrolo[2,3-b]pyridin-3-yl)pyrimidin-2-yl)amino)phenyl)boric acid may inhibit the activation of the STAT3 and Akt signal pathways (refer to FIGS. 6 and 7).
(5) (3-((5-chloro-4-(1H-pyrrolo[2,3-b]pyridin-3-yl)pyrimidin-2-yl)amino)phenyl)boric acid inhibits the cell migration ability of the glioblastoma in a dose-dependent way.

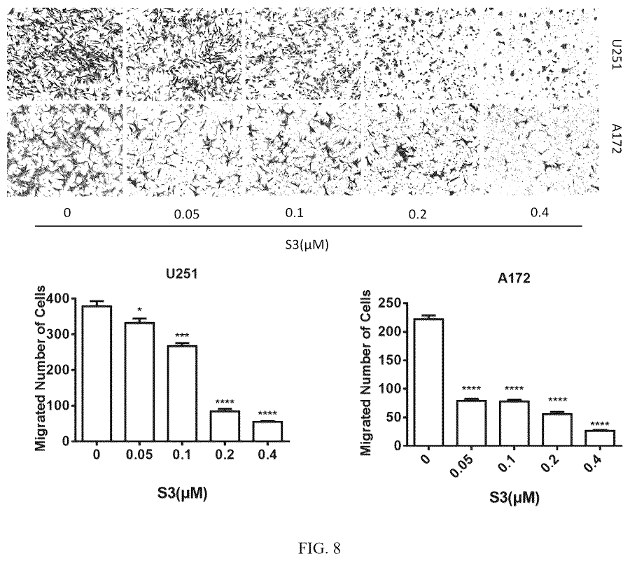

Then, in order to determine the effect of (3-((5-chloro-4-(1H-pyrrolo[2,3-b]pyridin-3-yl)pyrimidin-2-yl)amino)phenyl)boric acid on the cell migration ability of the glioblastoma, we treated, by the Transwell assay, the cells U251 and A172 with different concentrations of (3-((5-chloro-4-(1H-pyrrolo[2,3-b]pyridin-3-yl)pyrimidin-2-yl)amino)phenyl)boric acid and 24 h later, performed fixation and staining with 1% crystal violet methanol solution and observed the number of the migrating cells. The results showed that, without affecting cell proliferation, the treatment of (3-((5-chloro-4-(1H-pyrrolo[2,3-b]pyridin-3-yl)pyrimidin-2-yl)amino)phenyl)boric acid had significant cell migration inhibition effect on the cells U251 and A172, and the migration inhibition effect had dose dependence. The migration inhibition effect on the cells A172 was more obvious than that on the cells U251 (refer to FIG. 8).

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It should be understood that the present disclosure is not limited to the precise structure described above and shown in the accompanying drawings, and that various modifications and changes may be made without departing from the scope thereof. The scope of the present disclosure is limited only by the appended claims.

What is claimed is:

1. An N-heterocycle-containing boric acid compound, comprising a structural formula shown in formula (1): 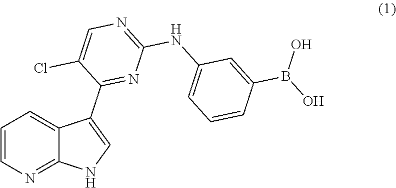 [SMILES: OB(O)c1cccc(Nc2ncc(Cl)c(-c3c[nH]c4ncccc34)n2)c1]
wherein a name of a chemical formula of the N-heterocycle-containing boric acid compound is (3-((5-chloro-4-(1H-pyrrolo[2,3-b]pyridin-3-yl)pyrimidin-2-yl)amino)phenyl)boric acid.

2. A preparation method of the N-heterocycle-containing boric acid compound of claim 1, wherein the preparation method is carried out in the following synthesis route:

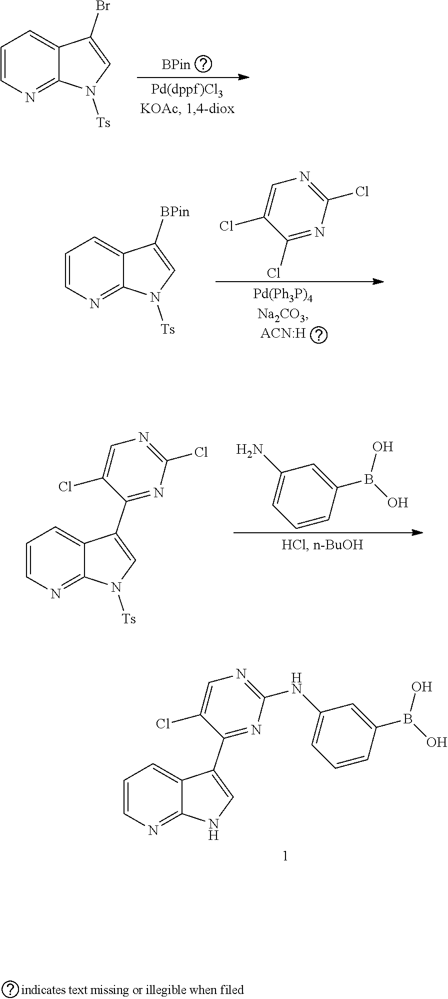

3. A preparation method of the N-heterocycle-containing boric acid compound of claim 1, comprising the following steps:
(1) conducting a first reaction with 3-bromo-1-p-tosyl-1H-pyrrolo[2,3-b]pyrimidine and bis(pinacolato)diboron under a catalysis of [1,1′-bis(diphenylphosphino)ferrocene]dichloropalladium to generate 3-(4,4,5,5-tetramethyl-1,3.2-dioxaborolan-2-yl)-1-tos-1H-pyrrolo[2,3-b]pyridine;
(2) conducting a second reaction with the 3-(4,4,5,5-tetramethyl-1,3,2-dioxaborolan-2-yl)-1-tos-1H-pyrrolo[2,3-b]pyridine and 2,4,5-trichloropyrimidine under a catalysis of tetrakis(triphenylphosphin)palladium to generate 3-(2,5-dichloropyrimidin-4-yl)-1-p-tolyl-1H-pyrrolo[2,3-b]pyridine; and
(3) conducting a reflux reaction with the_3-(2,5-dichloropyrimidin-4-yl)-1-p-tolyl-1H-pyrrolo[2,3-b]pyridine and 3-aminophenylboronic acid in a 5% HCl n-butyl alcohol solution to obtain the N-heterocycle-containing boric acid compound (3-((5-chloro-4-(1H-pyrrolo[2,3-b]pyridin-3-yl)pyrimidin-2-yl)amino)phenyl)boric acid.

4. A preparation method of the N-heterocycle-containing boric acid compound of claim 1, comprising the following steps:
(1) 3-bromo-1-p-tosyl-1H-pyrrolo[2,3-b]pyrimidine, bis(pinacolato)diboron, and potassium acetate are dissolved in ethylene glycol dimethyl ether and added with [1,1′-bis(diphenylphosphino)ferrocene]dichloropalladium under a protection of nitrogen, and displaced with nitrogen several times for a first reaction at a temperature of 90° C.; and after the first reaction is completed, a first reaction liquid is cooled and filtered and a filtrate is spin-dried and directly subjected to silica gel mixing and run through a first column to obtain 3-(4,4,5,5-tetramethyl-1,3,2-dioxaborolan-2-yl)-1-tos-1H-pyrrolo[2,3-b]pyridine;
(2) the 3-(4,4,5,5-tetramethyl-1,3,2-dioxaborolan-2-yl)-1-tos-1H-pyrrolo[2,3-b]pyridine, 2,4,5-trichloropyrimidine, and sodium carbonate are dissolved in an acetonitrile solution, and added with tetrakis(triphenylphosphin)palladium under the protection of nitrogen, and then displaced with nitrogen several times for a second reaction at a temperature of 85° C.; after the second reaction is completed, a second reaction liquid is cooled and filtered, and a filter cake is washed with water and vacuum-dried to obtain 3-(2,5-dichloropyrimidin-4-yl)-1-p-tolyl-1H-pyrrolo[2,3-b]pyridine;
(3) the 3-(2,5-dichloropyrimidin-4-yl)-1-p-tolyl-1H-pyrrolo[2,3-b]pyridine and 3-aminophenylboronic acid are dissolved in n-butyl alcohol, and added dropwise with concentrated hydrochloric acid, and subjected to a reflux reaction; after a solvent is evaporation-dried, a system is directly subjected to silica gel mixing and run through a second column to obtain the (3-((5-chloro-4-(1H-pyrrolo[2,3-b]pyridin-3-yl)pyrimidin-2-yl)amino)phenyl)boric acid

5. A preparation method of a drug for treating brain glioma, comprising using the N-heterocycle-containing boric acid compound of claim 1.
